(19) United States
(12) Patent Application Publication
(10) Pub. No.: US 2023/0218484 A1
(43) Pub. Date: Jul. 13, 2023

(54) Pill Bottle Storage And Organizer Device

(71) Applicant: Lee Green, Phoenix, AZ (US)

(72) Inventor: Lee Green, Phoenix, AZ (US)

(21) Appl. No.: 17/574,909

(22) Filed: Jan. 13, 2022

(51) Int. Cl. A61J 7/00; A61J 1/03

(52) U.S. Cl. CPC A61J 7/0084; A61J 1/03; A61J 2205/30

(57) ABSTRACT

A pill bottle storage and organizer device for storing and organizing pill bottles includes a base frame having a plurality of holes. The base frame has a front surface and a back surface. Each hole of the plurality of holes extends into the front surface of the base frame. The plurality of holes holds a respective one of a plurality of pill bottle bodies. Each hole of the plurality of holes enwraps the body of the pill bottle and the cap of the pill bottle is exposed to a user. A numbering on the caps of the pill bottles is on a label. Each number of the numbering on the caps of the pill bottles corresponds to a particular medication.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pill bottle organizer and more particularly pertains to a new pill bottle organizer for storing and organizing pill bottles.

### (2) Description of Related Art Including Information Disclosed Under 37 CFR 1.97 and 1.98

The prior art relates to pill bottle organizer. The prior art includes a variety of storage and organizing devices for pill bottles. Known prior art devices lack a pill bottle organizer being configured for enwrapping the body of the pill bottle leaving the cap of the pill bottle exposed to a user.

### BRIEF SUMMARY OF THE INVENTION

An embodiment of the disclosure meets the needs presented above by generally comprising a base frame having a rectangular shape and being elongated for a length. The base frame has a front surface and a back surface. The base frame has a width defined between the front surface and the back surface. The front surface has a plurality of holes wherein each hole of said plurality of holes extends into the front surface of the base frame. Each hole of the plurality of holes is configured for enwrapping a respective one of a plurality of pill bottle bodies. The cap of the pill bottle is exposed to the user. A numbering on the caps of the pill bottles is on label wherein the label is coupled to the cap of the pill bottles. Each number of the numbering on the caps of the pill bottles can correspond to a particular medication.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric in-use view of a pill bottle storage and organizer device according to an embodiment of the disclosure.

FIG. 2 is a back view of an embodiment of the disclosure.

FIG. 3 is a bottom view of an embodiment of the disclosure.

FIG. 4 is a side view of an embodiment of the disclosure.

FIG. 5 is a front view of an embodiment of the disclosure.

### DETAILED DESCRIPTION OF THE INVENTION

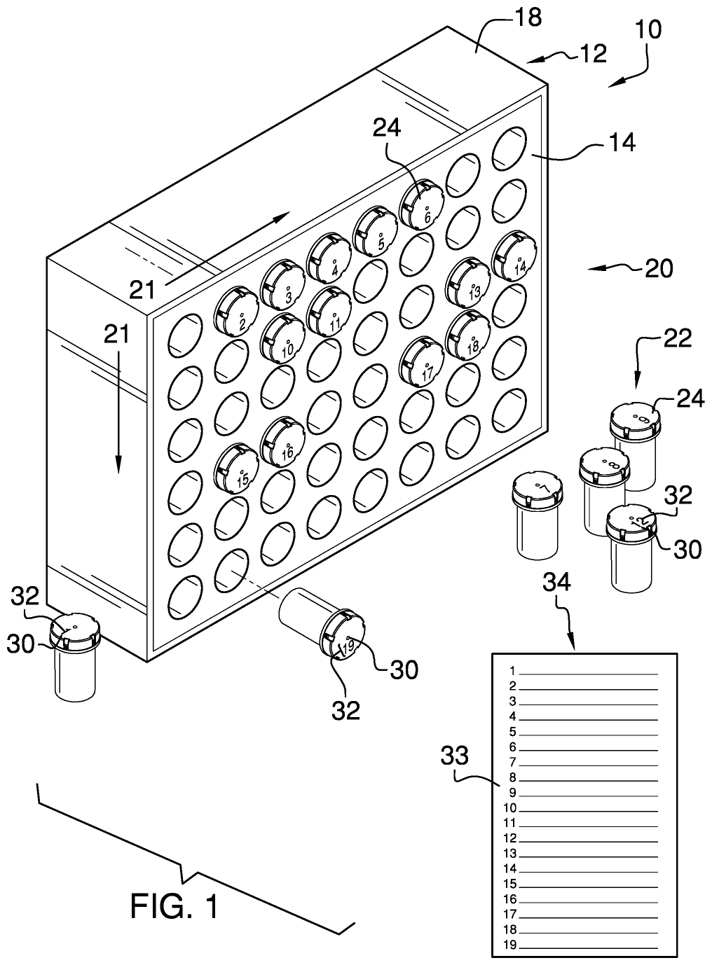

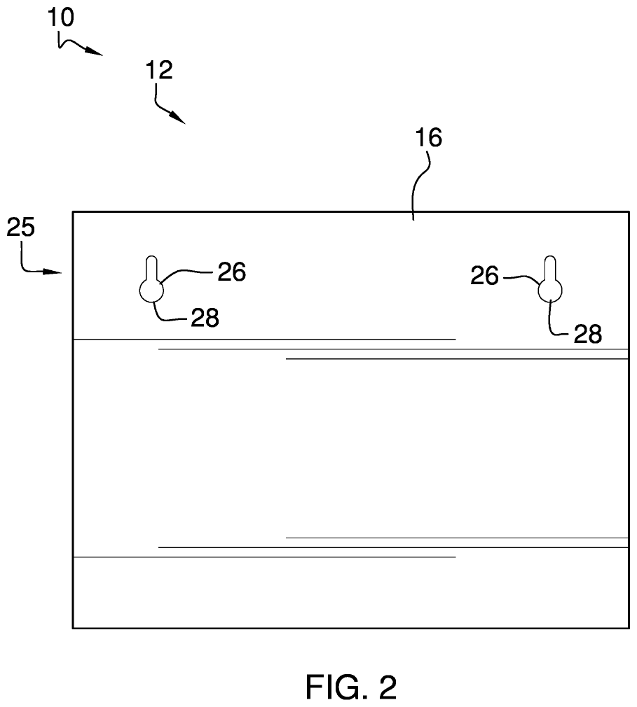

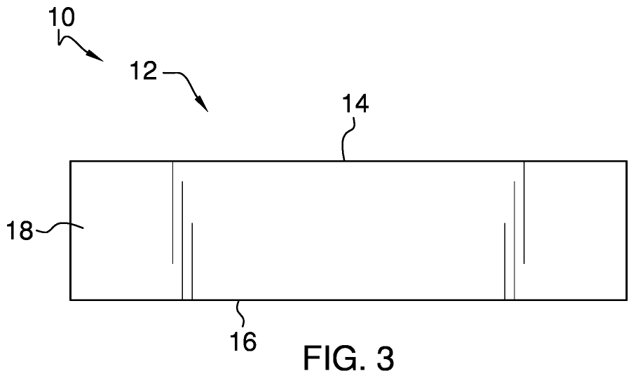

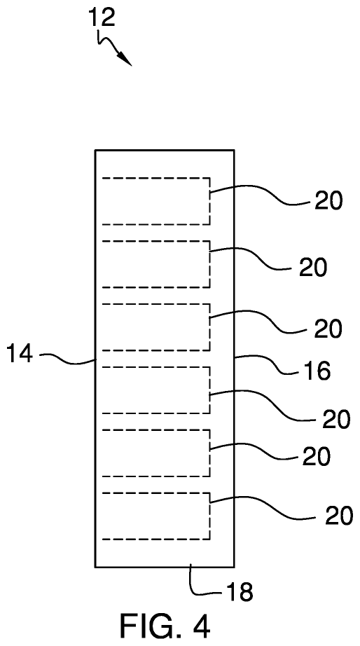

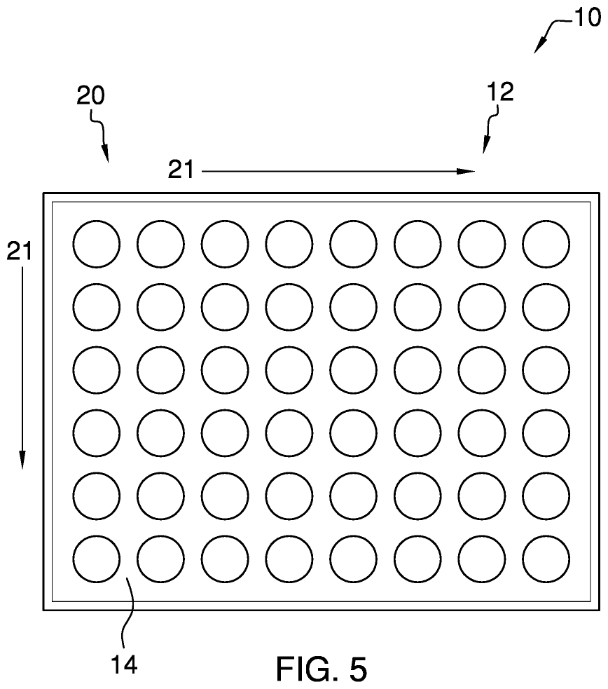

With reference now to the drawings, and in particular to FIGS. 1 through 5 thereof, a new pill bottle organizers embodying the principles and concepts of an embodiment of the disclosure and generally designated by the reference numeral 10 will be described.

As best illustrated in FIGS. 1 through 5, the pill bottle storage and organizer device 10 generally comprises a base frame 12. The base frame 12 has a front surface 14 and a back surface 16. The base frame 12 has a width 18 defined between the front surface 14 and the back surface 16.

The base frame 12 has a plurality of holes 20. Each hole of the plurality of holes 20 extends into the front surface 14 of the base frame 12. The plurality of holes 20 is configured for enwrapping a respective one of a plurality of pill bottle bodies 22. A cap 24 of each pill bottle body of the plurality of pill bottle bodies 22 is exposed to a user.

The plurality of holes 20 is positioned in a linear pattern 21 on the front surface. The linear pattern 21 is positioned perpendicular relative to the width 18. The linear pattern 21 is in a parallel direction relative to the front surface 14.

The back surface 16 of the base frame 12 has a pair of mounting holes 26. Each mounting hole of the pair of mounting holes 26 extends into the back surface 16 and has a circular shape 28. The pair of mounting holes 26 is positioned in a top 25 of the back surface 16 of the base frame 12. The pair of mounting holes 26 is configured for mounting the base frame 12 to a surface.

Each cap 24 of each pill bottle body of the plurality of pill bottle bodies 22 has a numbering 30. The numbering 30 is on a label 32. Each label 32 is coupled to a respective one of the caps 24 of each pill bottle body of the plurality of pill bottle bodies 22.

In use, the plurality of pill bottle bodies 22 is inserted into a respective one of the plurality of holes 20. Each of the pill bottle bodies 22 is enwrapped in each of the holes 20 wherein the cap 24 of the pill bottle body 22 is exposed. Each number of the numbering 30 on each cap 24 of the pill bottle bodies 22 corresponds to a particular medication 34. A list 33 holds the name of the particular medications 34.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A prescription bottle organizing device comprising:
a base frame, said base frame having a front surface and a back surface;
a plurality of holes, each hole of said plurality of holes extending into said front surface of said base frame, said plurality of holes being configured for holding a respective one of a plurality of pill bottle bodies wherein the caps of the pill bottles are exposed to a user; and
a numbering on the caps of the pill bottles, said numbering on the caps of the pill bottles is on a label.

2. The prescription bottle organizing device of claim 1, further comprising said base frame being elongated for a length and having a rectangular shape.

3. The prescription bottle organizing device of claim 1, further comprising said front surface and said back surface being parallel relative to each other, said base frame having a width defined between said front surface and said back surface.

4. The prescription bottle organizing device of claim 1, further comprising said plurality of holes being positioned in a linear pattern on said front surface, said linear pattern being positioned perpendicular relative to said width, said linear pattern being in a parallel direction relative to said front surface.

5. The prescription bottle organizing device of claim 1, further comprising a pair of mounting holes, each mounting hole of said pair of mounting holes having a circular shape.

6. The prescription bottle organizing device of claim 5, further comprising said pair of mounting holes being configured for inserting a mounting device wherein the mounting device mounts said base frame to a surface.

7. The prescription bottle organizing device of claim 1, further comprising said label is coupled to the caps of the pill bottles.

8. The prescription bottle organizing device of claim 1, further comprising said plurality of pill bottle bodies being in an arrangement, said arrangement being customizable such that said numbering on the caps of the pill bottles can correspond to a particular medication.

9. A prescription bottle organizing device comprising:
a base frame, said base frame being elongated for a length and having a rectangular shape, said base frame having a front surface and a back surface, said front surface and said back surface being parallel relative to each other, said base frame having a width defined between said front surface and said back surface;
a plurality of holes, each hole of said plurality of holes extending into said front surface of said base frame, said plurality of holes being configured for holding a respective one of a plurality of pill bottle bodies wherein the caps of the pill bottles are exposed to a user, said plurality of holes being positioned in a linear pattern on said front surface, said linear pattern being positioned perpendicular relative to said width, said linear pattern being in a parallel direction relative to said front surface;
a pair of mounting holes, each mounting hole of said pair of mounting holes having a circular shape, said pair of mounting holes being configured for inserting a mounting device wherein the mounting device mounts said base frame to a surface; and
a numbering on the caps of the pill bottles, said numbering on the caps of the pill bottles is on a label, said label is coupled to the caps of the pill bottles, said plurality of pill bottle bodies being in an arrangement, said arrangement being customizable such that said numbering on the caps of the pill bottles can correspond to a particular medication.
